(19) United States
(12) Patent Application Publication
(10) Pub. No.: US 2007/0221554 A1
(43) Pub. Date: Sep. 27, 2007

(54) Filter with pressure relief

(75) Inventor: Allen Buhr Wright, Hope Mills, NC (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/386,277

(22) Filed: Mar. 22, 2006

(51) Int. Cl. B01D 35/00

(52) U.S. Cl. 210/120; 210/767

(57) ABSTRACT

A cooling system is provided that includes a cap secured to a degas bottle. A filter that includes a frangible area is arranged within the degas bottle near the cap to separate the degas bottle into first and second sides. The frangible area is breakable in response to a predetermined pressure differential to provide an opening in the filter and connect the first and second sides. The filter includes a housing that supports mesh which filters debris and prevents the debris from reaching a valve in the cap. The opening in the broken frangible area bypasses the mesh in the event the mesh becomes clogged with debris. In operation, the inventive filter provides a simple method of releasing pressure in the cooling system. A wall of the filter is fractured once the differential pressure reaches the predetermined differential pressure. The inexpensive filter can then be replaced.

### BACKGROUND OF THE INVENTION

This invention relates to a filter for a degas bottle used in a coolant system and in particularly, a filter that also provides pressure relief.

Coolant systems for diesel engines utilize a degas bottle that acts as a coolant reservoir and relieves pressure within the cooling system. Pressure often increases in the cooling system during engine operation, so the degas bottle typically has included a cap with a valve for relieving the pressure. The cap is secured to a neck of the degas bottle, and a filter is arranged within the neck.

The filter is typically a molded structure having a mesh that prevents debris from clogging or negatively impacting the operation of the valve in the cap. Under rare conditions, it is possible for the filter to become clogged with debris such that the valve cannot relieve pressure within the degas bottle. This could result in a pressure within the degas bottle that exceeds the proof pressure of coolant lines within the cooling system. Accordingly, it is desirable to ensure that the valve can vent pressure in the event of a clogged filter.

One solution to the above-described problem of clogged filters has been to install yet another valve on the filter that is operated by a spring, or other biasing device, to keep it closed below a predetermined pressure differential. Although this method is reliable, it is quite costly. Furthermore, the valve on the filter may become stuck and fail to perform since it is normally in the closed position and operates very infrequently. What is needed is an inexpensive filter that provides pressure relief.

### SUMMARY OF THE INVENTION

A cooling system is provided that includes a cap secured to a degas bottle. A filter that includes a frangible area is arranged within the degas bottle near the cap to separate the degas bottle into first and second sides. The frangible area is breakable in response to a predetermined pressure differential to provide an opening in the filter that connects the first and second sides. The filter includes a housing that supports a mesh which filters debris and prevents the debris from reaching a valve in the cap. The opening formed by the broken frangible area provides a bypass of the mesh in the event that it becomes clogged with debris.

In operation, the inventive filter provides a simple method of releasing pressure in the cooling system. A wall of the filter is fractured once the differential pressure reaches the predetermined differential pressure. The inexpensive filter can then be replaced.

These and other features of the present invention can be best understood from the following specification and drawings, the following of which is a brief description.

### BRIEF DESCRIPTION OF THE DRAWINGS

FIG. 1 is a schematic view of a cooling system including a degas bottle and cap.

FIG. 2 is an enlarged cross-sectional view of a portion of the degas bottle shown in FIG. 1.

FIG. 3 is a perspective view of a filter, which is shown in FIG. 2.

FIG. 4 is a cross-sectional view of the filter taken along line 4-4 in FIG. 2.

FIG. 5 is an enlarged cross-sectional view of the filter taken along line 5-5 in FIG. 4.

FIG. 6 is a partially broken view of the filter shown in FIG. 5 in which the frangible area has been broken to bypass a mesh clogged with debris.

### DETAILED DESCRIPTION OF THE PREFERRED EMBODIMENT

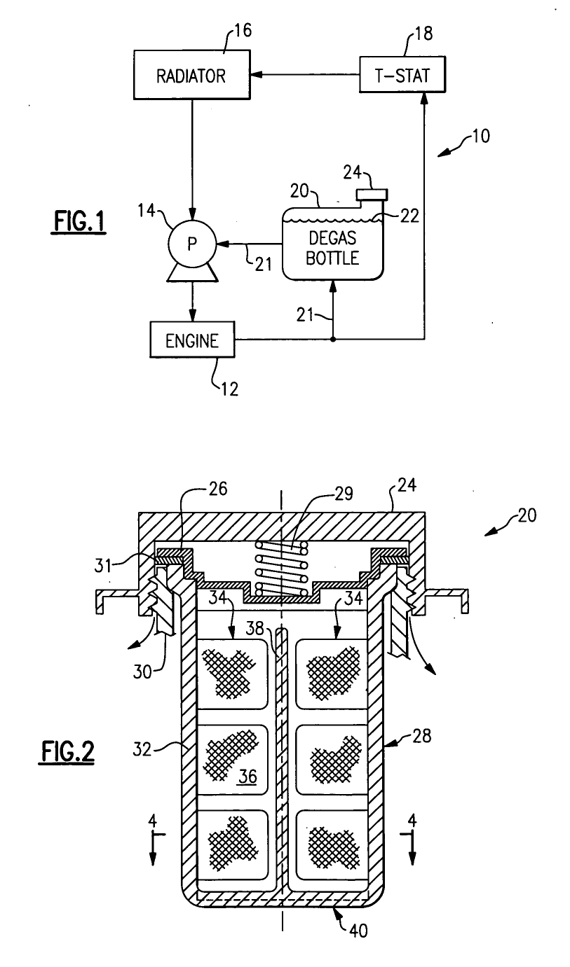

An example cooling system 10 is shown in FIG. 1, which is typical of the type found in a diesel-engine vehicle. The cooling system 10 includes an engine 12 that receives coolant from a pump 14. A radiator 16 is fluidly connected to the pump 14, and the flow through the radiator 16 is controlled by a thermostat 18. A degas bottle 20 is fluidly connected between the engine 12 and pump 14 by lines 21. These lines 21, or other lines in the cooling system 10, may have a proof pressure above which they will leak or burst. The degas bottle 20 acts as a reservoir for coolant 22 and includes a cap 24 for releasing pressure within the cooling system 10. The cooling system 10 shown in FIG. 1 is exemplary only, and the components shown may be different and arranged in any manner.

A portion of the degas bottle 20 is shown in FIG. 2. The degas bottle 20 includes a neck 30 that receives a filter 28. The cap 24 is secured to the neck 30 and includes a valve 26 for releasing pressure. A seal 31 is shown schematically arranged between the valve 26 and the neck 30 to release gas (shown by the arrows) when the valve 26 is in an open position, which is schematically illustrated in FIG. 2. The filter 28 separates the degas bottle 20 into two sides. One side is the side of the filter 28 exposed to the cap 24, and the other side is the opposite side of the filter 28. The filter 28 prevents debris from fouling the valve 26 and seal 31, which is based by spring 29, to ensure that their operation is not impaired.

The filter 28 includes a molded housing 32, typically constructed from a plastic such as nylon, that includes multiple apertures 34. Mesh 36, typically constructed from nylon that is arranged in a cylindrical shape, covers the apertures 34. The housing 32 is typically overmolded around the mesh 36. A tab 38 is provided by the housing 32 to facilitate removable of the filter 28 from the degas bottle 20.

In the example shown, the housing 32 includes a bottom 40 provided by a wall 42 that is normally closed or unbroken, as shown in FIGS. 2 and 3. During normal operation, gases can only pass through the mesh 36 of the filter 28. There are no perforations in the wall 42. For clarity, the mesh 36 is not shown in FIGS. 3-5. Referring to FIG. 5, the wall 42 has a thickness T1. In the example shown, the wall 42 is provided by a circumferential wall 44 and ribs 46, which are best shown in FIGS. 3 and 4. The wall 42 includes one or more recesses 48 that provide a frangible area 50 having a thickness T2 that is less than the thickness T1. The frangible area 50 is a weakened area designed to fracture or break at a predetermined differential pressure. In one example, it is desirable for the frangible area 50 to break prior to the mesh 36 breaking, which could undesirably permit debris to reach the valve 26.

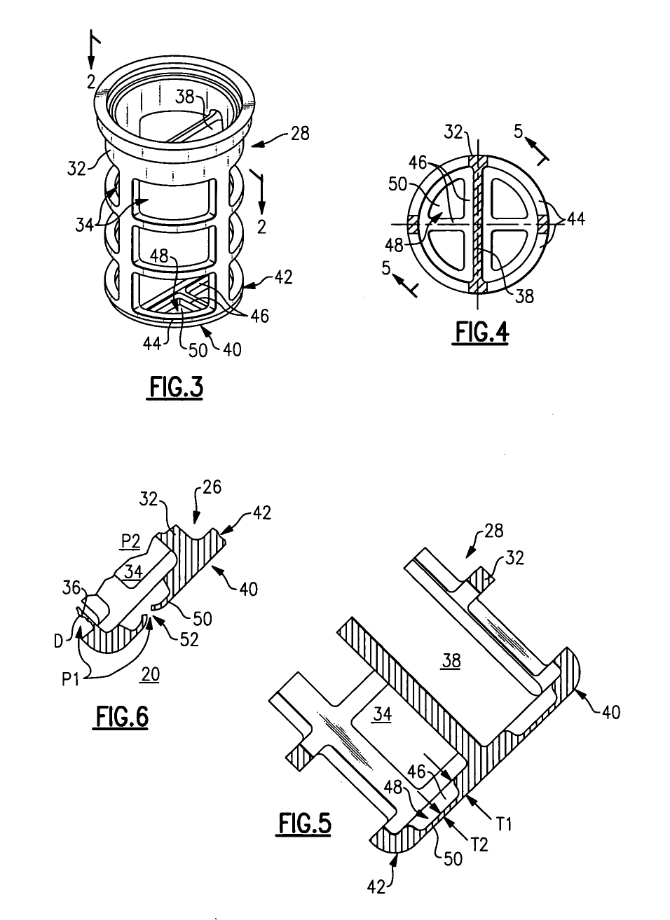

Referring to FIG. 6, the frangible area 50 is shown broken in response to a predetermined differential pressure, which provides an opening 52 that enables gas to escape the degas bottle 20 in the event that debris D clogs the mesh 36. The predetermined differential pressure is illustrated by a pressure P1 in a portion of the degas bottle 20 holding the coolant and a pressure P2 on an opposite side of the filter 28 near the cap 24. While the frangible area 50 is shown in the bottom 40 of the filter 28, it can be located anywhere on the filter 28. Further, the frangible area 50 is shown as being provided by a recessed area in a thicker wall 42. However, the frangible area 50 may be provided by a wall having a uniform thickness. That is, there need not be two discrete walls or thicknesses under this invention.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A filter comprising:
a housing supporting a mesh arranged between first and second sides, the housing providing an unbroken wall separating the first and second sides and having a frangible area in the unbroken wall for breaking at a predetermined differential pressure to provide an opening in the unbroken wall that is remote from the mesh and connects the first and second sides.

2. The filter according to claim 1, wherein the housing includes an aperture covered by the mesh.

3. The filter according to claim 2, wherein the housing is constructed from a plastic that is over molded onto the mesh.

4. The filter according to claim 2, wherein the housing includes multiple apertures generally arranged in a cylindrical shape, and the unbroken wall is provided at a bottom of the filter.

5. The filter according to claim 4, wherein the unbroken wall includes a portion having a first thickness and a recess providing the frangible area, the frangible area having a second thickness less than the first thickness.

6. The filter according to claim 4, wherein the first thickness is provided by a circumferential wall and ribs bounding the recess.

7. A cooling system comprising:
a cap secured to a degas bottle, and a filter having a frangible area that is arranged between the degas bottle and the cap to separate the degas bottle into first and second sides, the frangible area breakable in response to a predetermined differential pressure to provide an opening in the filter connecting the first and second sides.

8. The cooling system according to claim 7, wherein a line fluidly communicates with the degas bottle, the line including a proof pressure, and the predetermined differential pressure produced at a pressure within the degas bottle that is less than the proof pressure.

9. The cooling system according to claim 7, wherein the cap includes a valve that is exposed to the second side, the first side at a pressure less than a proof pressure of the cooling system.

10. The cooling system according to claim 7, wherein the filter includes a mesh for preventing debris from reaching the cap, the frangible area breaking prior to the mesh when clogged with debris.

11. The cooling system according to claim 7, wherein the degas bottle includes a neck supporting the cap, the filter arranged within the neck.

12. A method of releasing pressure in a cooling system comprising the steps of:
a) creating a differential pressure across a filter; and
b) fracturing a wall on the filter once the differential pressure reaches a predetermined differential pressure.

13. The method according to claim 12, wherein the differential pressure is provided by a first pressure within a degas bottle and a second pressure exposed to a cap on the degas bottle.

14. The method according to claim 13, wherein step b) occurs prior to the first pressure exceeding a proof pressure of the cooling system.
